(19) United States
(12) Patent Application Publication
(10) Pub. No.: US 2010/0221101 A1
(43) Pub. Date: Sep. 2, 2010

(54) SUPPORT OF FLOW DEFLECTION DEVICES IN WIND TURBINES

(76) Inventor: Daniel Farb, Beit Shemesh (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/681,890

(22) PCT Filed: Oct. 2, 2008
(86) PCT No.: PCT/IB08/54024

§ 371 Date: Apr. 7, 2010

(30) Foreign Application Priority Data
Oct. 7, 2007 (US) 60978119
Feb. 14, 2008 (US) 61028545
Jun. 3, 2008 (US) 61058235
Aug. 19, 2008 (US) 61089914

(51) Int. Cl. F03D 11/04; F03D 9/00; B23P 6/00; F03D 3/04; F03D 1/04

(52) U.S. Cl. 415/126; 290/55; 29/889

(57) ABSTRACT

Using flow deflection devices (FDD) or foils as part of wind and other turbines can add greatly to their performance, but designing the devices so that they fit together and on the turbines raises the need for new designs. This patent addresses the problem and describes solutions.

### FIELD AND BACKGROUND OF THE INVENTION

The present invention relates to a Flow Deflection Device (FDD), which is a foil or foil-like shape that increases the power output of a turbine by altering the circulation of the fluid, wherein “fluid” refers to liquid or gas.

The writer of the current patent has previously described innovations in FDDs, both typical foil-shaped and partial outline foils, in PCT IL2007/000348. The partial outline foils are a major step forward in performance, size, and weight. The current patent deals with solutions to special problems in making them and traditional foil shapes in conjunction with wind and other turbines so that they are adequately supported and attached in a cost-effective manner. The shape, weight, and structure require coordination with the turbine.

### BRIEF DESCRIPTION OF THE DRAWINGS

The invention is herein described, by way of example only, with reference to the accompanying drawings, wherein:

FIG. 1 is a diagram of a FDD support for a horizontal axis wind turbine.

FIG. 2 is a diagram of beams and ring segments.

FIG. 3 is a diagram of pivots and tracks.

FIG. 4 is a diagram of a ring and turbine on a tower.

FIG. 5 is a diagram of beams to hold a foil in place.

FIG. 6 is a diagram of beams and a foil.

FIG. 7 is a diagram of an outer connecting piece.

FIG. 8 is a diagram of parts and poles of a vertical axis turbine.

FIG. 9 is a diagram of a cage around a wind turbine.

FIG. 10 is a diagram of a base for a wind turbine.

FIG. 11 is a diagram of a vertical axis wind turbine combined with a streetlight.

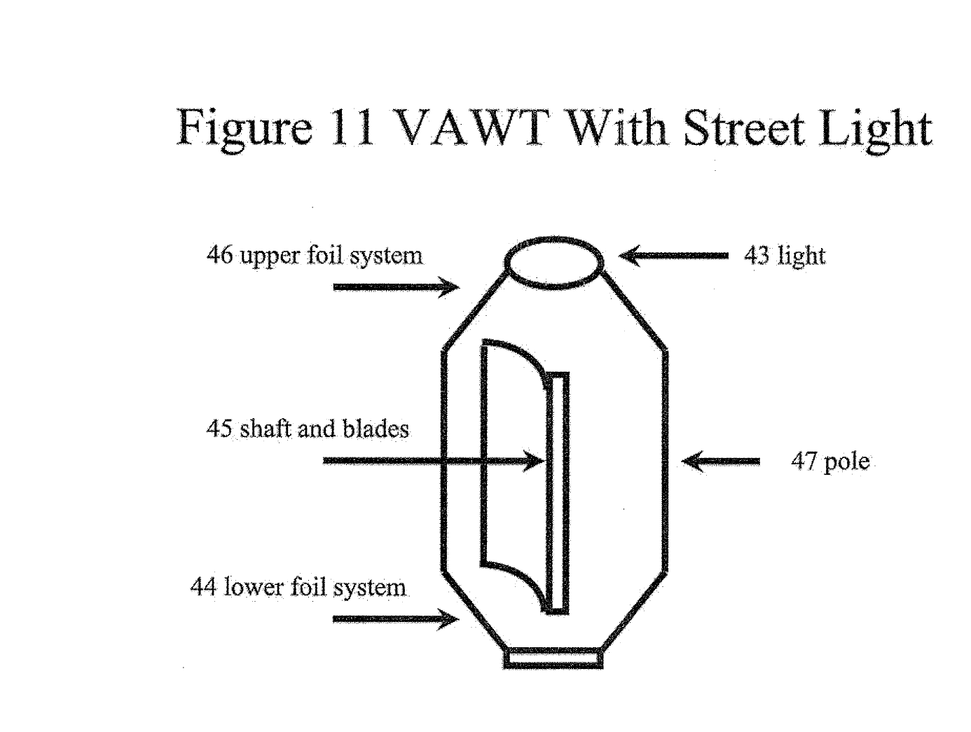

### DESCRIPTION OF THE PREFERRED EMBODIMENTS

The present invention relates to devices and methods for putting FDD foil structures in place on turbines.

Definitions: All FDDs referred to here are defined as being functionally adjacent to the blades, that is, in a position to cause a positive effect on velocity or power output.

The principles and operation of FDD supporting systems according to the present invention may be better understood with reference to the drawings and the accompanying description.

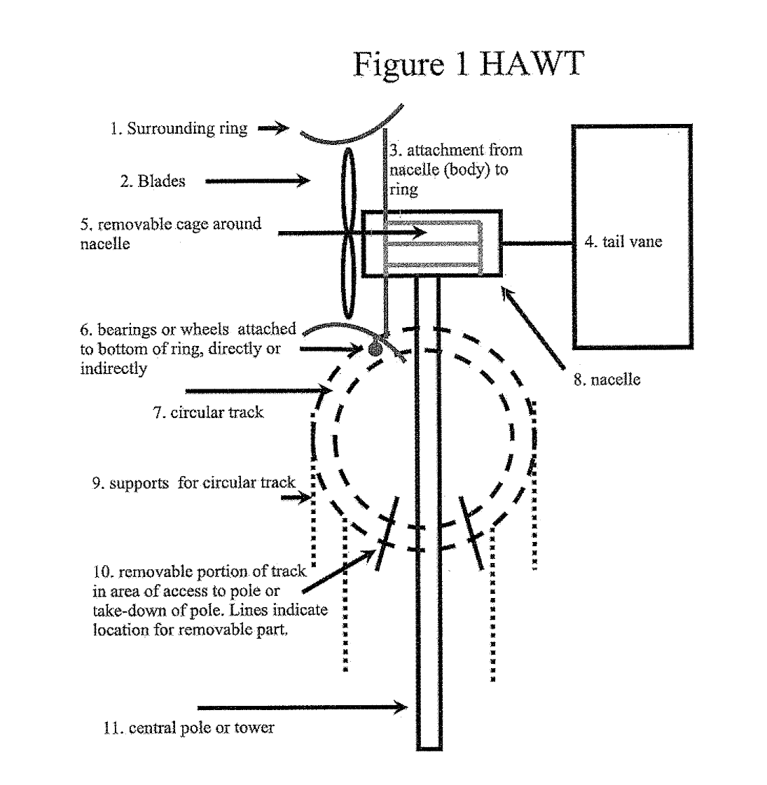

Referring now to the drawings, FIG. 1 illustrates a horizontal axis wind turbine, ideally for wind but also for water, whose flow deflection structure surrounds the blades (2) like a ring (1). The author already patented that in certain configurations, and other configurations are prior art not relevant to this application. The novel part is the support structure for the ring. It consists of a track (7) to which the FDD is attached. Bearings, wheels, or other means may be used. In one embodiment, they may have some adjustable “give” so as to make the connection from the ring to the track (6) easier to set up. The picture shows the ring attached directly to a bearing or wheel, but that is only one embodiment. In another embodiment, another piece may provide the connection to the track. The circular track enables the flow structure to move with the turbine blades and body. The track may also have a means to move radially in case the turbine angles vertically towards the fluid flow.

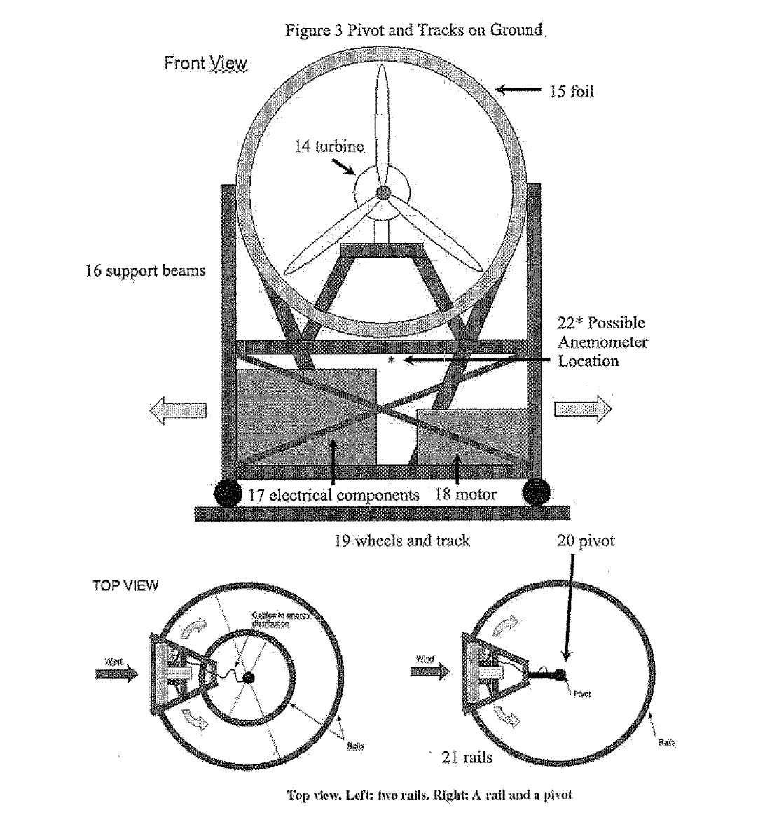

The movement around the track can be from a tail vane (4), which must be larger than most tail vanes since it has to move the additional weight of the foil. In one embodiment, said tail vane, for a turbine of 3 meters blade diameter or greater, should be of an area at least 20% of the swept area of the blades, said proportion being substantially greater than that of all current tail vanes. An electrical motor can also be used to move the structure on the track (18 in FIG. 3). The method of making the tail vane will be to make it of a size sufficient to overcome the directional effect of the wind on the ring that faces the wind in the front of the turbine, in front of the central tower.

Particularly in cases of a smaller turbine, which is erected from swinging or jacking up a pole (11), it will be useful as shown to locate an easily removable section of the track (10) in the direction of the raising and lowering of the pole.

The circular track may be located in the air, in the water, or attached to the ground using stands (9) or another structure.

An additional feature, not shown, to help stabilize the central pole in a case where the central pole is held up by cables, is making a strong piece of pipe that opens and closes via a joint, screw, or other attachment means, around the base of the pole and part of the pole. The point at which it closes around the pole can be locked into place.

The picture shows that, in one embodiment, the flow structure may be connected to the body of the turbine, or nacelle (8), by making a form-fitting structure (5) around the body that attaches by beams (3) to the foil. The beams may also attach from the flow structure directly to points on the nacelle. Note that it is aerodynamically advantageous to place the beams downstream of the blades.

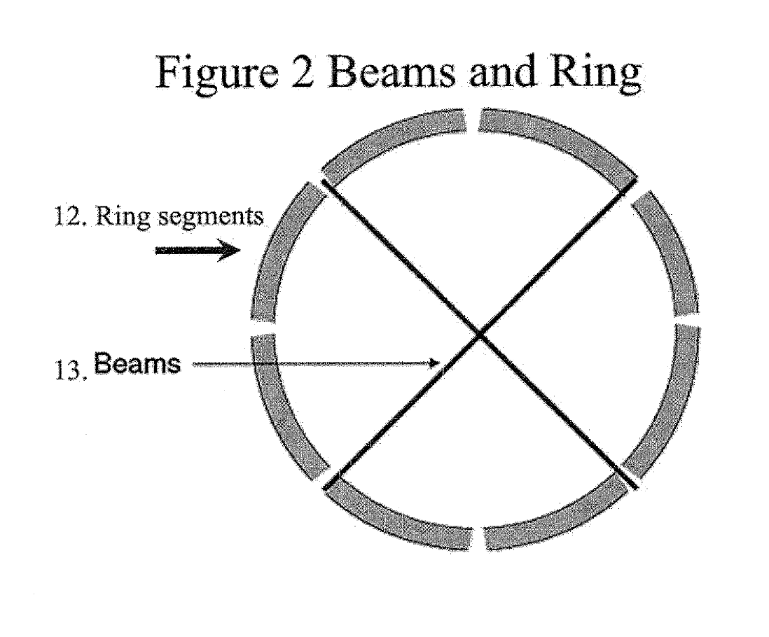

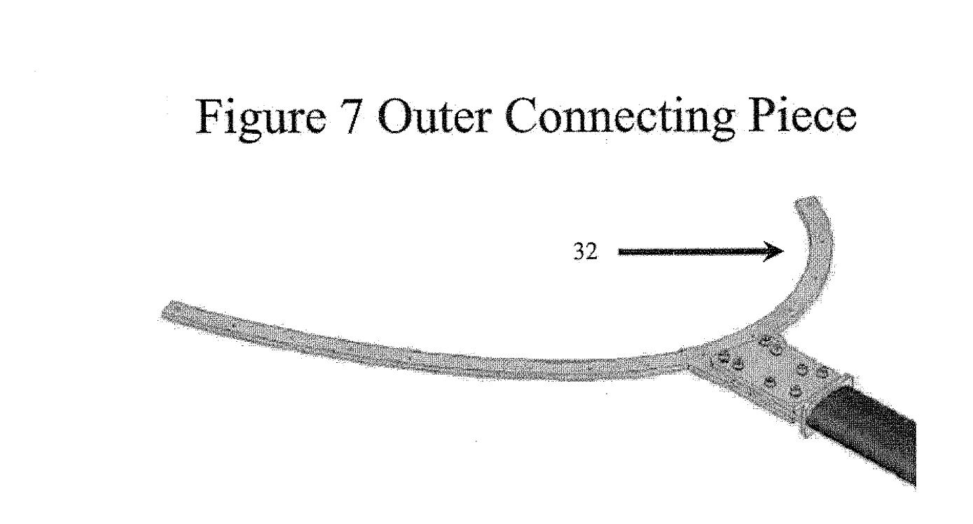

FIG. 2 illustrates that the ring is ideally made of smaller segments (12). This enables cheaper manufacturing. Materials may consist of fiberglass, composite, plastic, metal, or carbon fiber materials in some embodiments. The cross beams (13) have a section (32, FIG. 7) that fits into the spaces between the ring segments, in one embodiment. The advantage of this over prior art is minimizing alterations of the aerodynamics on the inside of the ring from attachments to the inner surface of the ring and relieving stress on the ring. It is better than to make the segments a large single piece.

FIG. 3 shows a device for combining an FDD (15) with a horizontal axis turbine (HAWT) (14) so that they can turn together into the wind. This addresses the problem of encircling a turbine separately connected to a tower with a heavy ring unsupported by anything other than a central tower. Here the support of both the ring and the turbine is on one connected structure (16), and they can move together on a pivot and/or rail (19, 20, 21). In the ideal embodiment, an anemometer (22) connected to a motor controls the motion so the turbine faces the wind. Electrical components (17) and a motor (18) may be mounted on the structure. The anemometer may be mounted on the turbine, on the side of the foil, or on the supporting structure, in different embodiments. A tail vane may be used alone or in conjunction with a motor to orient the system. Bearings, for example, may be substituted for the track and wheels.

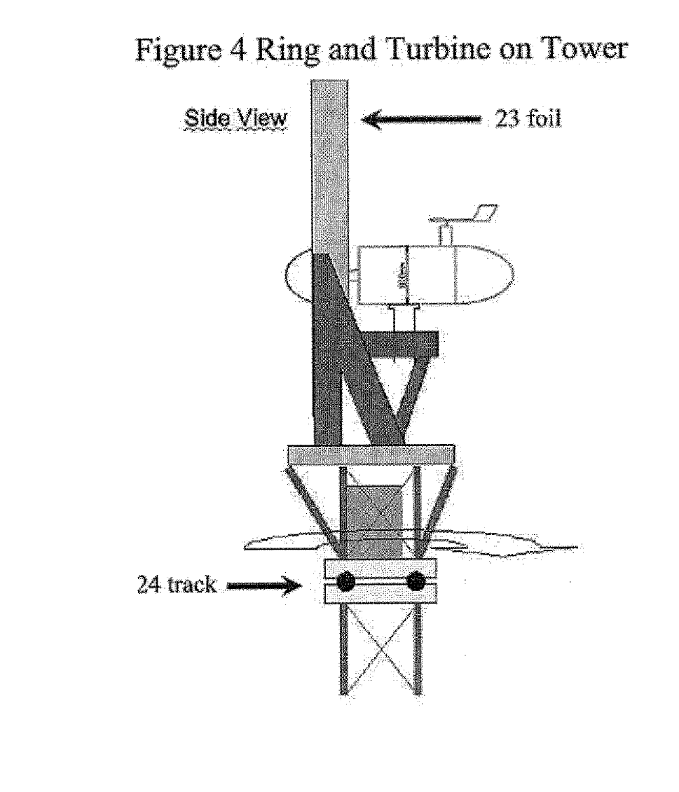

FIG. 4 shows a side view of a ring (23) and turbine on a tower—a similar arrangement to FIG. 3, except that the track (24) for rotation is on the tower.

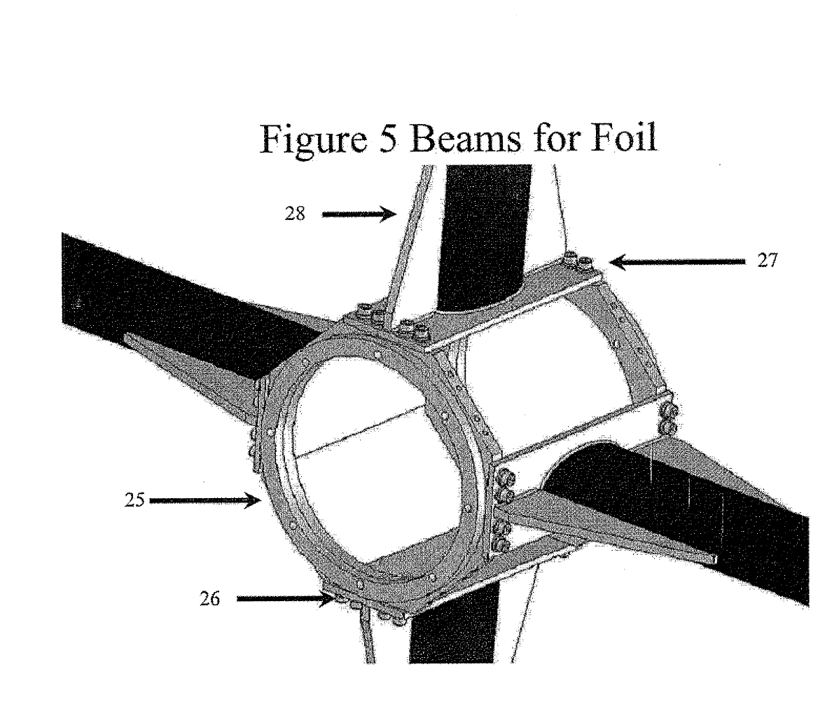

FIG. 5 is a close-up of one embodiment of the beams (27) holding the foil being attached to the nacelle instead of the structure holding the turbine. At least two circular structures attach fixedly to the nacelle body, or the attachment structures are incorporated into the nacelle itself (25); its outside has areas (26) for bolting the beam base to the nacelle and/or its attachment structures. The beams then connect from the base plate to the foils. In one embodiment, the beams have side support structures (28) attached to their length and at 90 degrees to the length of the base plate.

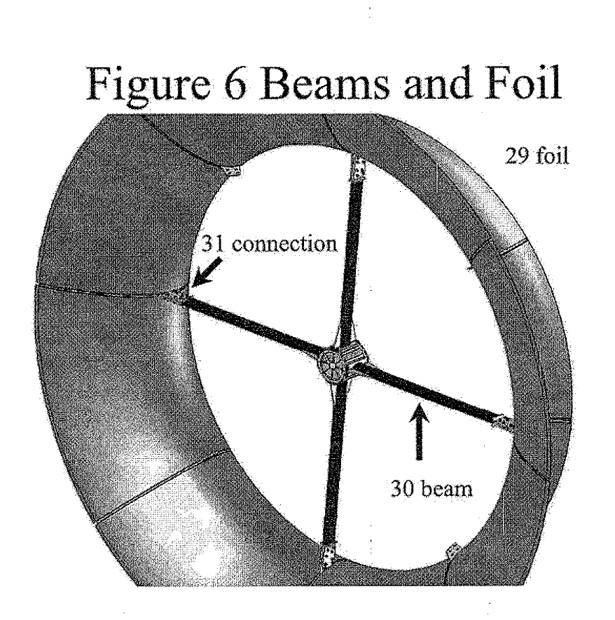

FIG. 6 is a broader view of the system. Beams (30) connect the foil (29) to the nacelle. The beams have a connection point (31) to the foil that is illustrated in FIG. 7. At the end of the beam, a thin connecting piece (32) connects the foils to the beams. The connecting piece at least partially follows the shape of the foil.

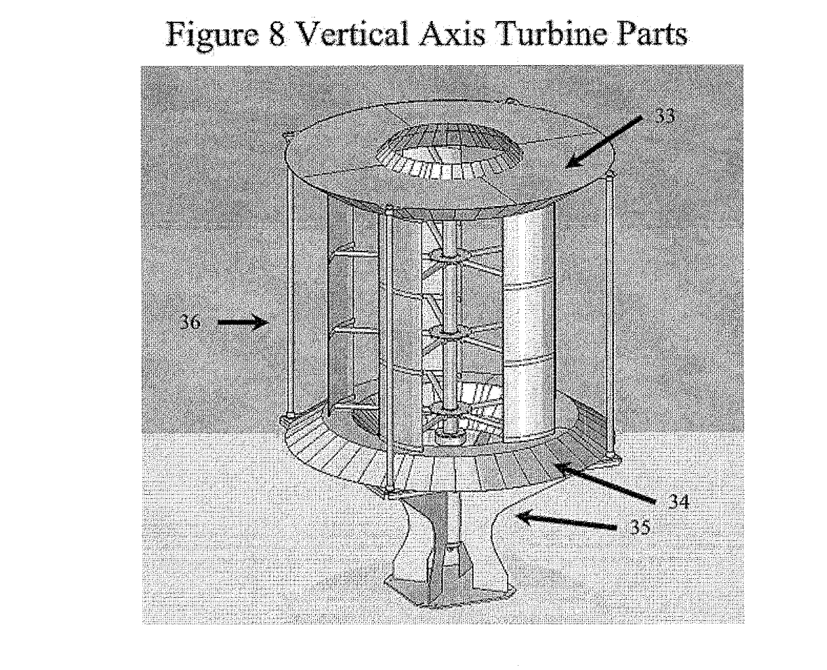

FIG. 8 shows that the same devices can be applied to a vertical axis turbine. The foils (34) are composed of many smaller segments of the same shape. The use of smaller segments for a foil shape in a vertical axis turbine, both as a device and as a method of manufacturing, is hereby introduced. Connecting pieces (35) are thin and fit in one embodiment between the foil pieces in order to form a connection from the foil to the base. This FDD of multiple segments may be placed below, above, or both, in relation to the blades in functional contiguity to increase the velocity in the area of the blades of any of the specific types associated with vertical axis wind turbines, such as giromills, Savoneus, and others, both drag and lift. Beams (36) attached to this first set of connecting pieces (35) and/or the foil (34) may then hold up an upper FDD (33). The flow structures are ideally made of segments. Materials may consist of fiberglass, composite, plastic, metal, or carbon-fiber materials in some embodiments. For extra stabilization, the poles (36) may also attach to the surface.

FIG. 8 shows that an FDD may be built of bent or straight segments of metal or other materials that approximate a rounded foil. The concept is hereby introduced of building a turbulence-inducing means such as a wire into the mold or bent pieces. (The author previously patented the use of such turbulence-inducing mechanisms; this addition relates to its method of manufacture.)

The upper flow structure in one embodiment has small holes to allow drainage of water and ice. It is shown here with a superior covering.

In one embodiment, the foil pieces have vertically positioned sides that have holes for bolts between segments. In one embodiment, the supports become thin as they approach the foil parts and fit in between such segments.

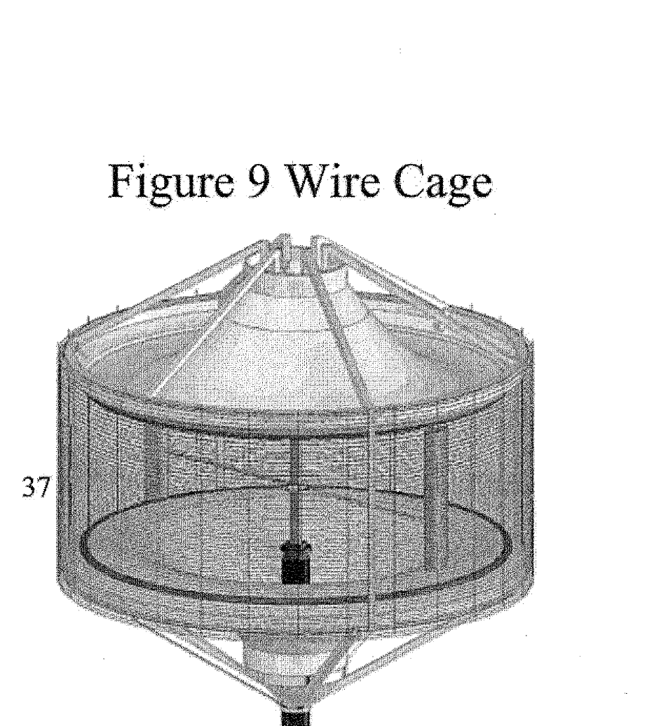

FIG. 9 shows an optional wire cage (37) placed on the flow deflection structure of a vertical axis turbine for added safety.

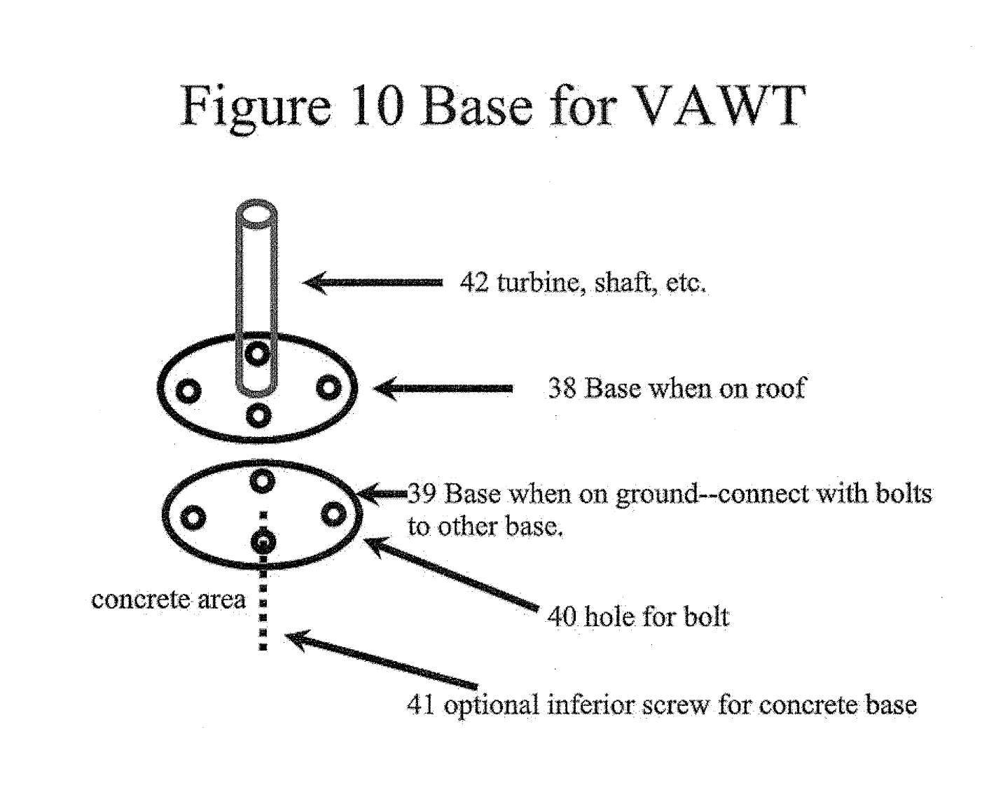

FIG. 10 shows a way to make a multifunctional base piece and save on installation and manufacturing costs for small wind turbines. The base (38) of the turbine (42) has holes for bolts and screws or other connecting means that can be used either to drill directly onto a roof or other base, or that can be connected to another base piece (39) inferior to it. Said second base piece can be inserted into the ground with concrete, for example, or other area with additional concrete, and then attach with means such as bolts (40) to the first base piece, shown above in the picture. The bottom base piece in one embodiment has an optional inferior piece such as a screw (41) for insertion into concrete.

The combination of a vertical axis turbine, with or without a battery, with an attached street lamp or other electrical appliance such as a cell tower (43), is hereby claimed. In one embodiment, it is used in combination with a vertical axis turbine with a foil system (44, 46, 47), which provides support for a device superior to the turbine.

The relationships of the flow structures to the blades can apply in other embodiments to turbines placed in other substances such as water throughout this application.

While the invention has been described with respect to a limited number of embodiments, it will be appreciated that many variations, modifications and other applications of the invention may be made.

### SUMMARY OF THE INVENTION

The present invention successfully addresses the shortcomings of the presently known configurations by providing a related set of devices for attaching turbine FDD parts.

It is now disclosed for the first time an FDD system, comprising:

a. a turbine and its supporting structure,
b. an FDD attached to either the turbine or its supporting structure or both,
c. a track or pivot with its corresponding pieces supporting the FDD or its turbine or both and enabling its movement to align with the fluid flow.

According to another embodiment, the turbine is a horizontal axis turbine.

According to another embodiment, the system is in the water.

According to another embodiment, the corresponding pieces have adjustable lengths.

In one embodiment, the system further comprises:

d. a second, congruent track or pivot with its corresponding pieces supporting the FDD or its turbine or both and enabling its movement to align with the fluid flow.

It is now disclosed for the first time an FDD turning system, comprising:

a. a turbine with an FDD,
b. a central tower,
c. a track surrounding the tower with its corresponding pieces supporting the FDD or its turbine or both and enabling its movement to align with the fluid flow.

It is now disclosed for the first time an FDD turning system, comprising:

a. a turbine with an FDD,
b. a tail vane whose surface area is at least 20% of the swept area of the blades for a turbine of 3 meters blade diameter or greater.

It is now disclosed for the first time a device for moving a horizontal axis turbine to catch the flow of a fluid, comprising:

a. a tail vane,
b. a motor.

In one embodiment, the system further comprises: c. an FDD surrounding the turbine blades.

It is now disclosed for the first time a tail vane, wherein the size of the tail vane and the distance of the vane from the center of rotation of the turbine have a combined torque greater than that of the torque on the foil surrounding the blades.

It is now disclosed for the first time a device for stabilizing a tower supporting a turbine whose tower is fixated by a group of cables and rotated into vertical position using a base on which a piece enables hoisting of the turbine tower from horizontal to vertical, comprising:

a. a surrounding piece that clamps over both the base and the lower part of the tower.

It is now disclosed for the first time an attachment system for a nacelle, comprising a separate, fixedly attached cage around the nacelle with at least one base to attach to other structures.

It is now disclosed for the first time an FDD turning system, comprising:

a. a turbine with an FDD,
b. a rotating means attached directly to the foil.

It is now disclosed for the first time an FDD turning system, comprising:

a. a wind turbine with an FDD,
b. a circular track surrounding an elevatable turbine tower pole,
c. a removable section of the track in the plane of take-down of the tower.

It is now disclosed for the first time an FDD system, comprising:

a. at least two ring segments,
b. attachment means on each side for attaching to the adjacent ring segment.
In one embodiment, the system further comprises: c. a thin connecting piece that fits between at least two ring segments with connection means to each of the two segments on one side and to another structure on the other side.

It is now disclosed for the first time a system for attaching beams to a nacelle, comprising:

a. at least one base plate (which may be part of the nacelle) attached to the nacelle,
b. at least one beam perpendicular to the base plate and attached to it,
c. an FDD, to which said beam attaches on the other side.
In one embodiment, the system further comprises: d. beam supports attached to the beam and the base plate or nacelle.

It is now disclosed for the first time an FDD system, comprising:

a. a vertical axis turbine with a foil,
b. a cage attached directly or indirectly to said foil.

It is now disclosed for the first time a method of manufacturing an FDD segment, wherein at least one circumferentially oriented bend exists in the FDD segment, operative to make the resulting shape an approximation of a rounded surface.

It is now disclosed for the first time a method of manufacturing an FDD, wherein a turbulence-inducing means is built into the mold or bent-piece segment.

It is now disclosed for the first time an FDD, comprising:

a. drainage holes.
(Said drainage holes are particularly useful for the upper FDD of a vertical axis turbine, and include by definition gaps between the foil segments if foil segments are used.)

It is now disclosed for the first time an FDD for a vertical axis wind turbine, comprising:

a. a slanted covering for the upper FDD, operative to drain liquid from the FDD.

It is now disclosed for the first time a base piece system for a turbine, comprising:

a. an upper base piece attached to the turbine,
b. a lower base piece, with complementary bolting areas, attached to the surface structure.
(Surface structure is defined to include such things as the ground or a rooftop.)

It is now disclosed for the first time an FDD system, comprising:

a. a supporting system for FDDs on a vertical axis turbine,
b. the upper FDD supporting system holds a connection for an appliance. (This support is defined as direct or indirect.)

According to another embodiment, the appliance is a telecommunication tower.

According to another embodiment, the appliance is a light.

According to another embodiment, the appliance is a lightning grounding system.

It is now disclosed for the first time an FDD support system for a vertical axis turbine, comprising:

a. at least two poles, fixedly attached to the lower FDD or the turbine structure, and attached to the upper FDD.

It is now disclosed for the first time an FDD support system for a vertical axis turbine, comprising:

a. at least two poles, fixedly attached to the ground surface, and attached to the upper FDD.

What is claimed is:

1-30. (canceled)

31. An FDD system, comprising:
a. a turbine and its supporting structure,
b. an FDD, with an axis in the axis of fluid flow, attached to either the turbine or its supporting structure or both,
c. at least one track or pivot with its corresponding pieces operative to support the FDD or its turbine or both and to enable its movement to align with the fluid flow.

32. An FDD turning system, comprising:
a. a turbine with an FDD,
b. a central tower,
c. a track surrounding the tower with its corresponding pieces supporting the FDD or its turbine or both and enabling its movement to align with the fluid flow.

33. A device for moving a horizontal axis turbine to catch the flow of a fluid, comprising:
a. a tail vane,
b. a motor.
c. an FDD surrounding the turbine blades.

34. A device for stabilizing a tower supporting a turbine whose tower is fixated by a group of cables and rotated into vertical position using a base on which a piece enables hoisting of the turbine tower from horizontal to vertical, comprising:
a. a surrounding piece that clamps over both the base and the lower part of the tower.

35. An FDD turning system, comprising:
a. a turbine with an FDD,
b. a rotating means attached directly to the foil.

36. An FDD turning system, comprising:
a. a wind turbine with an FDD,
b. a circular track surrounding an elevatable turbine tower pole,
c. a removable section of the track in the plane of take-down of the tower.

37. An FDD system for a renewable energy machine, comprising:
a. at least two ring segments,
b. attachment means on each side for attaching to the adjacent ring segment.

38. The system of claim³, further comprising:
c. a thin connecting piece that fits between at least two ring segments with connection means to each of the two segments on one side and to a supporting turbine structure on the other side.

39. An FDD system, comprising:
a. a vertical axis turbine with an FDD,
b. a cage attached directly or indirectly to said foil.

40. A method of manufacturing an FDD segment, wherein at least one circumferentially oriented non-rounded bend exists in the FDD segment operative to make the resulting shape an approximation of a rounded surface.

41. A method of manufacturing an FDD, wherein a turbulence-inducing means is built into the mold or bent-piece segment.

42. An FDD, comprising:
a. drainage holes.

43. An FDD system, comprising:
a. a supporting system for FDDs on a vertical axis turbine,
b. the upper FDD supporting system holds a connection for an appliance.

44. The system of claim 43, wherein the appliance is a telecommunication tower.

45. The system of claim 43, wherein the appliance is a light.
